(19) United States
(12) Patent Application Publication
(10) Pub. No.: US 2025/0246894 A1
(43) Pub. Date: Jul. 31, 2025

(54) PROTECTIVE RELAY DEVICE

(71) Applicant: Mitsubishi Electric Corporation, Tokyo (JP)

(72) Inventors: Reiji WATASE, Tokyo (JP); Shigetoo ODA, Tokyo (JP)

(73) Assignee: Mitsubishi Electric Corporation, Tokyo (JP)

(21) Appl. No.: 18/991,872

(22) Filed: Dec. 23, 2024

(30) Foreign Application Priority Data
Jan. 26, 2024 (JP) 2024-010402

(51) Int. Cl. H02H 1/00; G06F 21/71; H02H 7/045

(52) U.S. Cl. CPC H02H 1/0092; G06F 21/71; H02H 7/045

(57) ABSTRACT

A protective relay device includes a processor configured to: calculate a first effective value of a fundamental wave component of a differential current; calculate a second effective value of a second harmonic component of the differential current; determine whether a first condition is satisfied, the first condition being a condition that a ratio of the second effective value to the first effective value is equal to or more than a threshold value; perform a locking process for locking output of a protection signal, when the first condition is satisfied; and cancel the locking process based on a predetermined condition. When, within a first time period since a determination that the first condition is satisfied, a state in which the rate of change is less than a reference value continues for a second time period or longer, the processor outputs an unlock signal for canceling the locking process.

### CROSS REFERENCE TO RELATED APPLICATIONS

This nonprovisional application is based on Japanese Patent Application No. 2024-010402 filed on Jan. 26, 2024 with the Japan Patent Office, the entire contents of which are hereby incorporated by reference.

### BACKGROUND OF THE INVENTION

### Field of the Invention

The present disclosure relates to a protective relay device.

### Description of the Background Art

A ratio differential relay has been conventionally known as a protective relay that protects a facility constituting a power system. The ratio differential relay detects the occurrence of an internal fault of a device to be protected (e.g., a transformer), using a current taken in from a current transformer (CT) disposed in each of lines connected to the primary side and the secondary side of the device to be protected.

For example, Japanese Patent Laying-Open No. 11-299081 discloses a current differential relay. The current differential relay includes minimum operation determination means that outputs a signal when a differential current is equal to or more than a certain level, ratio determination means that outputs a signal when the differential current is equal to or more than a certain ratio, matching means that performs operation matching after both the minimum operation determination means and the ratio determination means operate, and locking means that locks or unlocks a signal output after operation matching.

When the device to be protected is a transformer, an exciting inrush current (hereinafter, also referred to as “inrush current”) occurs when the transformer is charged or when a power transmission line interconnected to the transformer is reclosed. The inrush current causes a malfunction of the ratio differential relay. Therefore, in order to deal with the malfunction, a second harmonic locking method using the fact that the inrush current includes a certain amount or more of a second harmonic component has generally been adopted.

An internal fault current of the transformer in a normal state hardly includes the second harmonic component. However, when a system fault occurs and the current increases suddenly, a ratio (hereinafter, also referred to as “content rate”) of the second harmonic component to a fundamental wave component increases transiently at the timing of sudden increase in the current due to a filter circuit of the protective relay and computation of an effective value of the second harmonic component. At this time, the content rate exceeds a set value and thus second harmonic locking functions transiently, which leads to a delay in operation of the protective relay.

Japanese Patent Laying-Open No. 11-299081 adopts a configuration in which operation matching is performed after both the minimum operation determination means and the ratio operation determination means operate, and a signal output after operation matching is locked, in order to allow quick relay operation at the time of a system fault. According to this configuration, operation matching is started even during false locking at the time of a system fault, and thus, the operation after cancellation of the locking can be shortened. However, the technique according to Japanese Patent Laying-Open No. 11-299081 is essentially the technique of delaying the operation of the protective relay until the locking caused by transient detection of the second harmonic component is canceled. Therefore, there is room for improvement in a delay in operation of the protective relay.

An object in an aspect of the present disclosure is to provide a protective relay device that does not malfunction when an inrush current occurs and can operate immediately when a fault occurs.

### SUMMARY OF THE INVENTION

According to an embodiment, a protective relay device for protecting a device to be protected is provided. The protective relay device includes: a processor; and a memory that stores a program executed by the processor. The processor is configured to: calculate a first effective value of a fundamental wave component of a differential current calculated from a primary current and a secondary current of the device to be protected; calculate a second effective value of a second harmonic component of the differential current; determine whether a first condition is satisfied, the first condition being a condition that a ratio of the second effective value to the first effective value is equal to or more than a threshold value; perform a locking process for locking output of a protection signal for protecting the device to be protected, when the first condition is satisfied; and cancel the locking process based on the first condition and a rate of change in the second effective value. When, within a first time period since a determination that the first condition is satisfied, a state in which the rate of change is less than a reference value continues for a second time period or longer, the processor is configured to output an unlock signal for canceling the locking process.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a diagram showing a power system to which a protective relay device according to the present embodiment is applied.

FIG. 2 is a diagram showing an example of a hardware configuration of the protective relay device according to the present embodiment.

FIG. 3 is a block diagram showing a functional configuration of a protective relay device according to a first embodiment.

FIG. 4A is a diagram for illustrating a determination method by a determination unit.

FIG. 4B is a diagram for illustrating a determination method by a determination unit.

FIG. 5 is a diagram showing temporal changes in various computed values according to the first embodiment when a fault occurs.

FIG. 6 is a diagram showing an example of temporal changes in various computed values according to the first embodiment when an inrush current occurs.

FIG. 7 is a diagram showing another example of temporal changes in various computed values according to the first embodiment when an inrush current occurs.

FIG. 8 is a diagram showing still another example of temporal changes in various computed values according to the first embodiment when an inrush current occurs.

FIG. 9 is a timing chart for illustrating an operation example of the protective relay device according to the first embodiment when a fault occurs.

FIG. 10 is a timing chart for illustrating an example of the operation of the protective relay device according to the first embodiment when an inrush current is applied.

FIG. 11 is a timing chart for illustrating another example of the operation of the protective relay device according to the first embodiment when an inrush current is applied.

FIG. 12 is a timing chart for illustrating still another example of the operation of the protective relay device according to the first embodiment when an inrush current is applied.

FIG. 13 is a block diagram showing a functional configuration of a protective relay device according to a second embodiment.

FIG. 14 is a diagram showing temporal changes in various computed values according to the second embodiment when a fault occurs.

FIG. 15 is a diagram showing an example of temporal changes in various computed values according to the second embodiment when an inrush current occurs.

FIG. 16 is a diagram showing another example of temporal changes in various computed values according to the second embodiment when an inrush current occurs.

FIG. 17 is a diagram showing still another example of temporal changes in various computed values according to the second embodiment when an inrush current occurs.

FIG. 18 is a timing chart for illustrating an operation example of the protective relay device according to the second embodiment when a fault occurs.

FIG. 19 is a timing chart for illustrating an example of the operation of the protective relay device according to the second embodiment when an inrush current is applied.

FIG. 20 is a timing chart for illustrating another example of the operation of the protective relay device according to the second embodiment when an inrush current is applied.

FIG. 21 is a timing chart for illustrating still another example of the operation of the protective relay device according to the second embodiment when an inrush current is applied.

FIG. 22 is a block diagram showing a functional configuration of a protective relay device according to a third embodiment.

### DESCRIPTION OF THE PREFERRED EMBODIMENTS

The present embodiment will be described hereinafter with reference to the drawings. In the following description, the same components are denoted by the same reference characters. Their names and functions are also the same. Therefore, detailed description about them will not be repeated.

### [Configuration as Basis of Each Embodiment]

### <Overall Configuration>

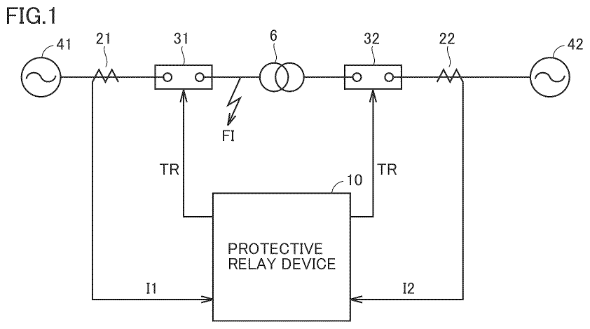

FIG. 1 is a diagram showing a power system to which a protective relay device according to the present embodiment is applied. Referring to FIG. 1, a transformer 6 serving as a device to be protected, a circuit breaker 31 placed on the primary side (e.g., the high-pressure side) of transformer 6, a circuit breaker 32 placed on the secondary side (e.g., the low-pressure side) of transformer 6, current transformers 21 and 22, a protective relay device 10, a high-pressure-side AC power supply 41, and a low-pressure-side AC power supply 42 are provided in the power system. Each of AC power supplies 41 and 42 is, for example, a three-phase (e.g., an a phase, a b phase and a c phase) AC power supply.

Current transformer 21 detects a primary current (e.g., a high-pressure-side current) I1 flowing through a primary-side line connected to a primary winding of transformer 6. Current transformer 22 detects a secondary current (e.g., a low-pressure-side current) I2 flowing through a secondary-side line connected to a secondary winding of transformer 6. When each of AC power supplies 41 and 42 is a three-phase AC power supply, current transformer 21 is provided in each of an a-phase line, a b-phase line and a c-phase line on the primary side, and current transformer 22 is provided in each of an a-phase line, a b-phase line and a c-phase line on the secondary side.

Current transformer 21 corresponding to the a phase detects a primary current I1a flowing through the a-phase line, current transformer 21 corresponding to the b phase detects a primary current I1b flowing through the b-phase line, and current transformer 21 corresponding to the c phase detects a primary current I1c flowing through the c-phase line. Similarly, current transformer 22 corresponding to the a phase detects a secondary current I2a flowing through the a-phase line, current transformer 22 corresponding to the b phase detects a secondary current I2b flowing through the b-phase line, and current transformer 22 corresponding to the c phase detects a secondary current I2c flowing through the c-phase line. Primary current I1 is a generic term for primary currents I1a, I1b and I1c, and secondary current I2 is a generic term for secondary currents I2a, I2b and I2c.

When protective relay device 10 detects an internal fault FI (e.g., a ground fault or a short circuit fault) within a protection range surrounded by current transformers 21 and 22 using primary current I1 received from current transformer 21 and secondary current I2 received from current transformer 22, protective relay device 10 outputs an open command (e.g., a trip signal TR) to circuit breakers 31 and 32 placed at both ends of transformer 6. As a result, circuit breakers 31 and 32 are opened and the fault section (here, transformer 6) is separated from the power system. Typically, protective relay device 10 performs a ratio differential relay computation based on primary current I1 and secondary current I2.

### <Hardware Configuration>

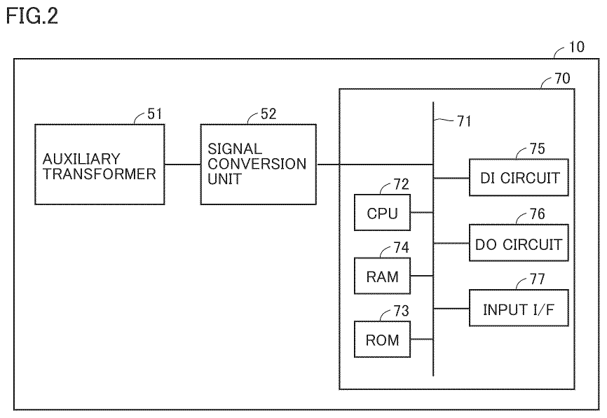

FIG. 2 is a diagram showing an example of a hardware configuration of the protective relay device according to the present embodiment. Referring to FIG. 2, protective relay device 10 includes an auxiliary transformer 51, a signal conversion unit 52 and a computation processing unit 70.

Auxiliary transformer 51 takes in the current detected by each of current transformers 21 and 22, converts the current into a voltage signal suitable for signal processing in a relay internal circuit, and outputs the voltage signal. Signal conversion unit 52 takes in the voltage signal output from auxiliary transformer 51, and converts the voltage signal into digital data. Specifically, signal conversion unit 52 includes an analog filter, a sample hold circuit, a multiplexer, and an analog to digital (A/D) converter.

The analog filter removes a harmonic component from a waveform signal of the current output from auxiliary transformer 51. The sample hold circuit samples the waveform signal of the current output from the analog filter at a predetermined sampling cycle. Based on a timing signal input from computation processing unit 70, the multiplexer sequentially switches the waveform signal input from the sample hold circuit in chronological order, and inputs the waveform signal to the A/D converter. The A/D converter converts the waveform signal input from the multiplexer from analog data to digital data. The A/D converter outputs the digitally converted waveform signal (i.e., the digital data) to computation processing unit 70.

Computation processing unit 70 is configured mainly by a microcomputer and includes a central processing unit (CPU) 72, a ROM 73, a RAM 74, a digital input (DI) circuit 75, a digital output (DO) circuit 76, and an input interface (I/F) 77. These are coupled to each other by a bus 71.

CPU 72 controls the operation of protective relay device 10 by reading and executing a program prestored in ROM 73. RAM 74 serving as a volatile memory and ROM 73 serving as a non-volatile memory are used as main storages of CPU 72. ROM 73 stores the program, a set value for signal processing, and the like. CPU 72 is, for example, a microprocessor.

CPU 72 takes in the digital data from signal conversion unit 52 through bus 71. CPU 72 performs a relay computation using the taken in digital data, in accordance with the program stored in ROM 73. CPU 72 determines the presence or absence of a fault (i.e., detects a fault) based on a result of the relay computation.

When CPU 72 detects a fault, CPU 72 outputs a signal to the outside through digital output circuit 76. For example, digital output circuit 76 outputs trip signal TR to circuit breakers 31 and 32. CPU 72 receives a signal from the outside through digital input circuit 75. Input interface 77 is typically various buttons or the like, and receives various setting operations from a system operator.

At least a part of protective relay device 10 may be configured using circuitry such as a field programmable gate array (FPGA) and an application specific integrated circuit (ASIC). At least a part of protective relay device 10 can also be configured by an analog circuit.

### First Embodiment

### <Functional Configuration>

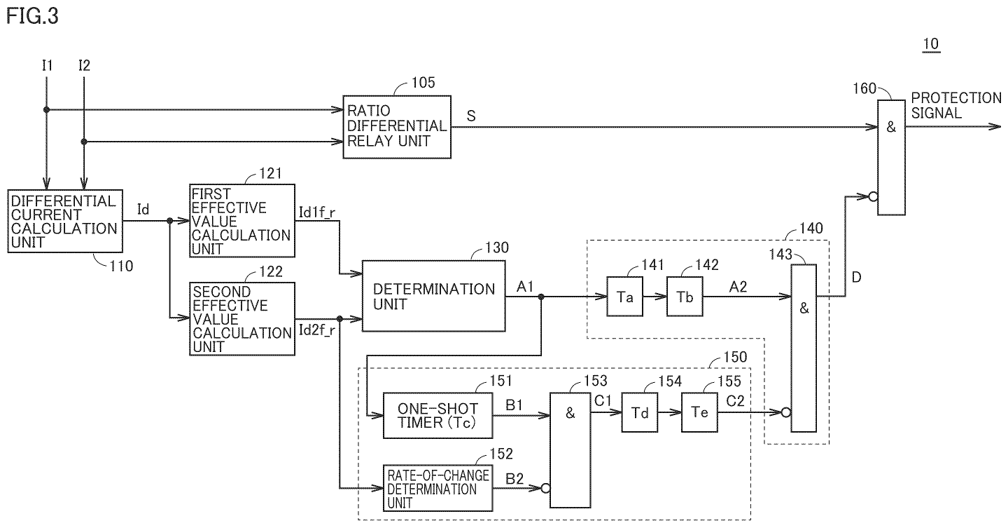

FIG. 3 is a block diagram showing a functional configuration of protective relay device 10 according to a first embodiment. Referring to FIG. 3, protective relay device 10 includes, as its main functional configuration, a ratio differential relay unit 105, a differential current calculation unit 110, a first effective value calculation unit 121, a second effective value calculation unit 122, a determination unit 130, a locking process unit 140, an unlocking unit 150, and an output control unit 160. These functions are, for example, implemented by CPU 72 of protective relay device 10 executing the program stored in the memory (e.g., ROM 73, RAM 74). Some or all of these functions may be implemented by hardware.

Ratio differential relay unit 105 and differential current calculation unit 110 receive inputs of primary current I1 and secondary current I2. Each of primary current I1 and secondary current I2 input to these components is a current subjected to gain compensation processing based on a CT winding ratio and a transformation ratio of transformer 6 and phase compensation processing based on a winding configuration, so as to prevent a differential current from occurring in the relay computation even when a through current flows through transformer 6 due to a fault outside the protection range or the like.

Ratio differential relay unit 105 outputs a protection signal (e.g., a signal S having the value “1”) for protecting the device to be protected (e.g., transformer 6), based on a result of the ratio differential relay computation. The protection signal corresponds to the open command to open circuit breakers 31 and 32, for example.

Specifically, ratio differential relay unit 105 performs a filtering process for extracting a fundamental wave component of the power system (e.g., a system voltage, a system current) on primary current I1 and secondary current I2 subjected to compensation, to calculate a differential current Idx and a suppression current Irx using primary current I1x and secondary current I2x subjected to the filtering process. For example, ratio differential relay unit 105 calculates an effective value of a vector sum of primary current I1x and secondary current I2x as differential current Idx. Ratio differential relay unit 105 calculates a scalar sum of an effective value of primary current I1x and an effective value of secondary current I2x as suppression current Irx. Although the effective values are used in the present disclosure, “effective value” can be converted into “amplitude value/√2”, and thus, all of the effective values may be replaced with the amplitude values. The subscript “x” of each of “I1x”, “I2x”, “Idx”, and “Irx” represents any one phase of the three phases (e.g., the a phase, the b phase and the c phase).

Ratio differential relay unit 105 performs the ratio differential relay computation based on suppression current Irx and differential current Idx calculated from primary current I1 and secondary current I2. Ratio differential relay unit 105 determines whether such a relationship that differential current Idx is equal to or more than a value obtained by multiplying suppression current Irx by a constant α and is equal to or more than a constant β (Idx≥α×Irx and Idx≥β) is satisfied, for example. When suppression current Irx and differential current Idx satisfy the above-described relationship, ratio differential relay unit 105 outputs the protection (operation) signal. Ratio differential relay unit 105 outputs signal S having the value “1” when ratio differential relay unit 105 outputs the protection signal (i.e., when ratio differential relay unit 105 performs a relay operation), and outputs signal S having the value “0” when ratio differential relay unit 105 does not perform the relay operation.

Differential current calculation unit 110 calculates a differential current Id from primary current I1 and secondary current I2. Specifically, differential current calculation unit 110 calculates a vector sum of primary current I1 and secondary current I2 subjected to compensation as differential current Id. Differential current Id is input to first effective value calculation unit 121 and second effective value calculation unit 122.

First effective value calculation unit 121 calculates an effective value Id1f_r of a fundamental wave component of differential current Id calculated from primary current I1 and secondary current I2. Specifically, first effective value calculation unit 121 performs the filtering process on differential current Id using a first filter that extracts a fundamental wave component of the power system, to calculate effective value Id1f_r of the fundamental wave component of differential current Id having passed through the first filter. The first filter is configured as a filter having frequency characteristics that allow a fundamental wave component of a power system to pass therethrough and do not allow the other components such as a DC component, a second harmonic component, a third harmonic component, and a fourth harmonic component to pass therethrough.

Second effective value calculation unit 122 calculates an effective value Id2f_r of a second harmonic component of differential current Id. Specifically, second effective value calculation unit 122 performs the filtering process on differential current Id using a second filter that extracts the second harmonic component of the power system, to calculate effective value Id2f_r of the second harmonic component of differential current Id having passed through the second filter. The second filter is configured as a filter having frequency characteristics that allow a second harmonic component of a power system to pass therethrough and do not allow the other components such as a DC component, a fundamental wave component, a third harmonic component, and a fourth harmonic component to pass therethrough.

Determination unit 130 receives inputs of effective value Id1f_r and effective value Id2f_r at a certain time t, and calculates a ratio of effective value Id2f_r to effective value Id1f_r (i.e., Id2f_r/Id1f_r) as a second harmonic content rate R2. Determination unit 130 determines whether a condition P1 that second harmonic content rate R2 is equal to or more than a threshold value K (e.g., 10% to 15%) is satisfied. Condition P1 is “(Id2f_r/Id1f_r)≥K”.

In addition, determination unit 130 determines whether a condition P1a that a ratio of effective value Id2f_r to a rated current Ira of transformer 6 (i.e., Id2f_r/Ira) is equal to or more than a threshold value k1 (e.g., 2%) is satisfied. Condition P1a is “(Id2f_r/Ira)≥k1”. Furthermore, determination unit 130 determines whether a condition P1b that a ratio of effective value Id1f_r to rated current Ira (i.e., Id1f_r/Ira) is equal to or more than a threshold value k2 (e.g., 10%) is satisfied. Condition P1b is “(Id1f_r/Ira)≥k2”. Assuming that a minimum operation value (e.g., constant β) of ratio differential relay unit 105 is 20% of the rated current and a minimum value of threshold value K of condition P1 is 10%, a minimum value (i.e., threshold value k1) required to lock output of the protection signal (i.e., signal S having the value “1”) is 2% (=20%×10%). From the above, threshold value k2 may only be less than a minimum value of constant β, and thus, is set to 10%, which is less than 20%, in this case.

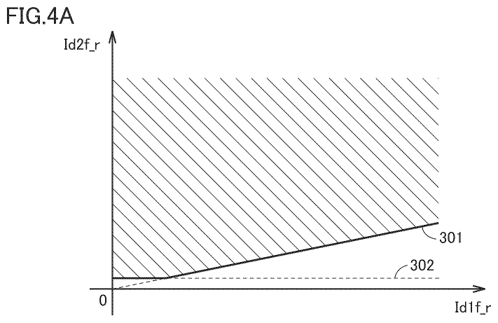

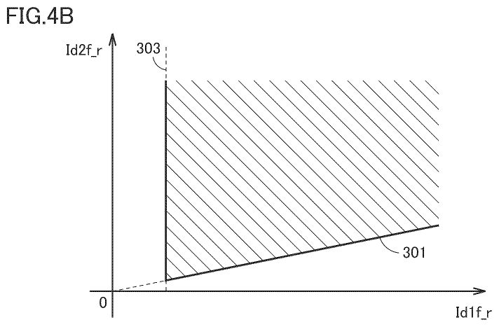

FIGS. 4A and 4B are diagrams for illustrating a determination method by the determination unit. Referring to FIG. 4A, a straight line 301 is a straight line represented by “(Id2f_r/Id1f_r)=K” (i.e., a straight line relating to condition P1), and a straight line 302 is a straight line represented by “(Id2f_r/Ira)=k1” (i.e., a straight line relating to condition P1a). Referring to FIG. 4B, a straight line 303 is a straight line represented by “(Id1f_r/Ira)=k2” (i.e., a straight line relating to condition P1b).

In an aspect, determination unit 130 outputs a signal A1 having the value “1” when condition P1 and condition P1a are satisfied (i.e., when a coordinate (Id1f_r, Id2f_r) is present in a hatched region shown in FIG. 4A), and otherwise outputs signal A1 having the value “0”.

In another aspect, determination unit 130 outputs signal A1 having the value “1” when condition P1 and condition P1b are satisfied (i.e., when the coordinate (Id1f_r, Id2f_r) is present in a hatched region shown in FIG. 4B), and otherwise outputs signal A1 having the value “0”.

In still another aspect, determination unit 130 outputs signal A1 having the value “1” when all of condition P1, condition P1a and condition P1b are satisfied, and otherwise outputs signal A1 having the value “0”.

Referring again to FIG. 3, when at least condition P1 is satisfied, locking process unit 140 performs a locking process for locking output of the protection signal (e.g., signal S having the value “1”) for protecting the device to be protected (e.g., transformer 6). Specifically, locking process unit 140 includes an operation timer 141, a reset timer 142 and an AND circuit 143.

When the value “1” of signal A1 output from determination unit 130 continues for a time period Ta or longer, operation timer 141 outputs the value “1” to reset timer 142. Time period Ta is set to, for example, the electrical angle of 30° (i.e., 1/12 cycle). In the present embodiment, one cycle corresponds to the electrical angle of 360°.

When the output value of operation timer 141 changes from “0” to “1”, reset timer 142 switches its own output value (i.e., a value of a signal A2) to “1” immediately. When the output value of operation timer 141 changes from “1” to “0” and the “0” state continues for a certain time period (e.g., a time period Tb) or longer, reset timer 142 switches its own output value to “0”. Specifically, after time period Tb elapses since the point in time at which the output value of operation timer 141 has changed from “1” to “0”, reset timer 142 outputs signal A2 having the value “0”. Time period Tb is set to, for example, the electrical angle of 120° (i.e., ⅓ cycle).

AND circuit 143 performs an AND operation between the output value of reset timer 142 and an output value of unlocking unit 150 inverted in logic level. Specifically, when the output value of reset timer 142 is “1” and the output value of unlocking unit 150 is “0” (i.e., when an unlock signal for cancelling locking is not output by unlocking unit 150), AND circuit 143 outputs a signal D having the value “1” (e.g., a lock signal for locking output of the protection signal). The process of outputting signal D having the value “1” corresponds to the locking process for locking output of the protection signal.

Unlocking unit 150 cancels the locking process by locking process unit 140 based on a result of determination by determination unit 130 and a rate of change in effective value Id2f_r. Specifically, unlocking unit 150 includes a one-shot timer 151, a rate-of-change determination unit 152, an AND circuit 153, an operation timer 154, and a reset timer 155.

When determination unit 130 outputs signal A1 having the value “1”, one-shot timer 151 continues to output a signal B1 having the value “1” to AND circuit 153 for a time period Tc. When time period Tc has elapsed, one-shot timer 151 outputs signal B1 having the value “0” to AND circuit 153. Time period Tc is set to, for example, the electrical angle of 270° (i.e., ¾ cycle).

Rate-of-change determination unit 152 determines whether effective value Id2f_r of the second harmonic component has changed by a certain value or more, using Equation (1) below. “Ts” in Equation (1) is, for example, the electrical angle of 30°. In Equation (1), the rate of change in effective value Id2f_r is calculated by dividing a difference between a current effective value Id2f_r (t) and an effective value Id2f_r (t−Ts) time period Ts before by current effective value Id2f_r (t).

$$\{ Id2f\_r ( t ) - Id2f\_r ( t - T s ) \} / Id2f\_r ( t ) \geq ε \qquad ( 1 )$$

Take the left side of Equation (1) as a rate of change ΔId2f_r in effective value Id2f_r. In this case, when rate of change ΔId2f_r is equal to or more than a reference value ε (e.g., 1% to 50%) (i.e., ΔId2f_r≥ε), rate-of-change determination unit 152 outputs a signal B2 having the value “1”. When rate of change ΔId2f_r is less than reference value ε (i.e., ΔId2f_r<ε), rate-of-change determination unit 152 outputs signal B2 having the value “0”.

AND circuit 153 performs an AND operation between the output value of one-shot timer 151 and the output value of rate-of-change determination unit 152 inverted in logic level. Specifically, when the output value of one-shot timer 151 is “1” and the output value of rate-of-change determination unit 152 is “0” (i.e., when effective value Id2f_r has not changed by the certain value or more), AND circuit 153 outputs a signal C1 having the value “1”.

When the value “1” of signal B1 output from AND circuit 153 continues for a time period Td or longer, operation timer 154 outputs the value “1” to reset timer 155. Time period Td is set to, for example, the electrical angle of 150° (i.e., 5/12 cycle).

When the output value of operation timer 154 changes from “0” to “1”, reset timer 155 switches its own output value (i.e., a value of a signal C2) to “1” immediately. When the output value of operation timer 154 changes from “1” to “0” and the “0” state continues for a time period Te or longer, reset timer 155 outputs signal C2 having the value “0”. Time period Te is set to, for example, the electrical angle of 210° (i.e., 7/12 cycle). Signal C2 having the value “1” corresponds to an unlock signal for canceling the locking process by locking process unit 140.

From the above, when, within time period Tc since the determination by determination unit 130 that at least condition P1 is satisfied, the state in which rate of change ΔId2f_r is less than reference value ε continues for time period Td or longer, unlocking unit 150 outputs the unlock signal.

Output control unit 160 outputs the protection signal for protecting transformer 6, based on a result of the ratio differential relay computation by ratio differential relay unit 105 and whether the locking process is performed by locking process unit 140. Specifically, when ratio differential relay unit 105 is operating and the locking process is not being performed by locking process unit 140 (e.g., the locking process has been canceled), output control unit 160 determines that an internal fault of the device to be protected (e.g., transformer 6) has occurred, and outputs the protection signal. In contrast, when the locking process is being performed by locking process unit 140 (e.g., the lock signal is being output) even if ratio differential relay unit 105 is operating, output control unit 160 locks output of the protection signal (i.e., locks output of signal S having the value “1”).

Output control unit 160 is configured as an AND circuit, for example. Output control unit 160 performs an AND operation between the output value of ratio differential relay unit 105 and the output value of locking process unit 140 (specifically, AND circuit 143) inverted in logic level. When the output value of ratio differential relay unit 105 is “1” and the output value of locking process unit 140 is “0”, output control unit 160 outputs the value “1”. That is, output control unit 160 outputs the protection signal from ratio differential relay unit 105.

In contrast, when the output value of locking process unit 140 is “1” even if the output value of ratio differential relay unit 105 is “1” (i.e., the locking process is being performed even if ratio differential relay unit 105 is operating), output control unit 160 outputs the value “0”. That is, output control unit 160 does not output the protection signal from ratio differential relay unit 105.

### <Temporal Changes in Various Computed Values>

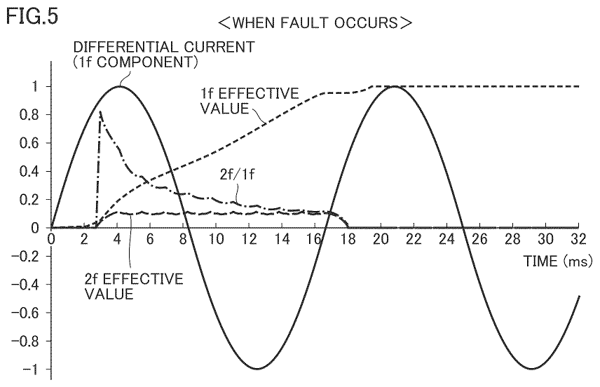

FIG. 5 is a diagram showing temporal changes in various computed values according to the first embodiment when a fault occurs. The vertical axis in FIG. 5 represents second harmonic content rate R2 (corresponding to “2f/1f” in the figure), which is the ratio of effective value Id2f_r to effective value Id1f_r, and the horizontal axis in FIG. 5 represents the time. Referring to FIG. 5, the current of the fundamental wave component increases suddenly when a fault occurs, and thus, the fundamental wave component of the differential current corresponding to “differential current (1f component)” in the figure increases in amplitude. Effective value Id1f_r of the fundamental wave component corresponding to “1f effective value” in the figure increases gradually due to influences of the filter for extraction of the fundamental wave component and a data length used in effective value computation.

In this transition period during current variation, effective value Id2f_r of the second harmonic component corresponding to “2f effective value” in the figure becomes almost constant several milliseconds after the fault occurs. The length of the transition period depends on the filter for extraction of the second harmonic component used in protective relay device 10 and the data length used in effective value computation. In the example shown in FIG. 5, the transition period is approximately one cycle after the sudden change of the current. After the transition period elapses, the differential current does not include the second harmonic component, and thus, effective value Id2f_r becomes zero.

In a time period for which effective value Id1f_r of the fundamental wave component is small, second harmonic content rate R2 (corresponding to “2f/1f” in the figure) is high, and thus, it is determined that the current waveform contains the second harmonic component. In this way, the second harmonic component is also detected in the fault current waveform that does not include the second harmonic component, and thus, the operation of protective relay device 10 is locked. As the time period of locking becomes longer, the operation to open the circuit breakers becomes later.

Next, temporal changes in various computed values when an inrush current occurs will be described. According to the international standard for transformer protective relays, IEC60255-187-1, it is required that a transformer protective relay should not malfunction due to an inrush current. Thus, in accordance with the standard definition, it is necessary to confirm that the transformer protective relay does not malfunction when a conduction angle α of the inrush current is 60°, 90° and 120°. Therefore, temporal changes in various computed values when each of the inrush current having conduction angle α of 60°, the inrush current having conduction angle α of 90°, and the inrush current having conduction angle α of 120° occurs (e.g., when each of simulated inrush currents is applied) will be described below.

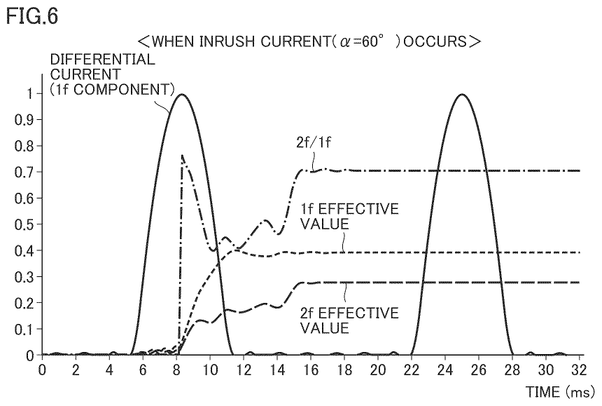

FIG. 6 is a diagram showing an example of temporal changes in various computed values according to the first embodiment when the inrush current occurs. The vertical axis and the horizontal axis in FIG. 6 represent second harmonic content rate R2 and the time, respectively. Referring to FIG. 6, “differential current (1f component)” in the figure represents the inrush current having conduction angle α of 60°. In comparison with the example when the fault occurs as shown in FIG. 5, a characteristic difference is that effective value Id2f_r is not constant but changing in the transition period during current variation. Effective value Id2f_r eventually settles to a certain value.

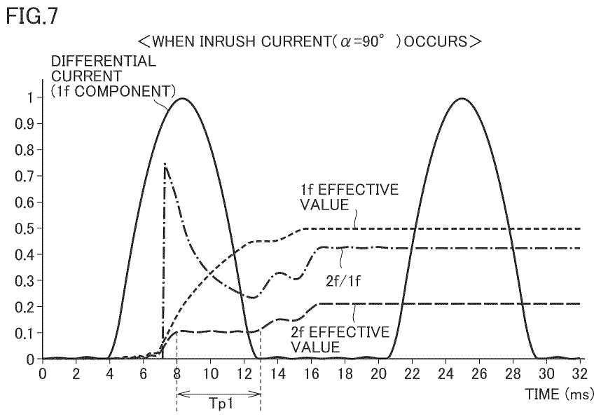

FIG. 7 is a diagram showing another example of temporal changes in various computed values according to the first embodiment when the inrush current occurs. The vertical axis and the horizontal axis in FIG. 7 represent second harmonic content rate R2 and the time, respectively. Referring to FIG. 7, “differential current (1f component)” in the figure represents the inrush current having conduction angle α of 90°. In the example shown in FIG. 7, effective value Id2f_r is almost constant in a time period Tp1 (e.g., 5 ms) of the transition period during current variation. However, similarly to the example shown in FIG. 6, effective value Id2f_r is changing in the other time period of the transition period. Effective value Id2f_r eventually settles to a certain value.

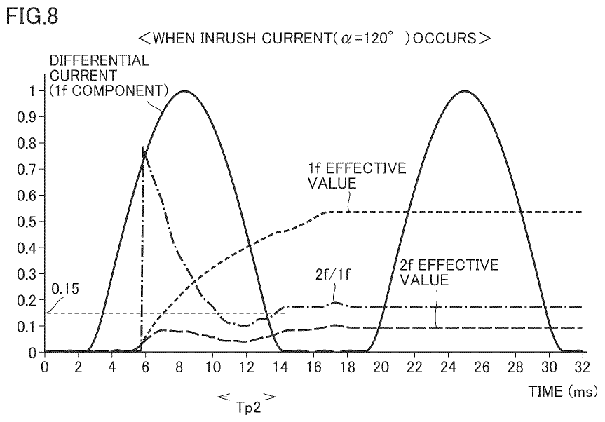

FIG. 8 is a diagram showing still another example of temporal changes in various computed values according to the first embodiment when the inrush current occurs. The vertical axis and the horizontal axis in FIG. 8 represent second harmonic content rate R2 and the time, respectively. Referring to FIG. 8, “differential current (1f component)” in the figure represents the inrush current having conduction angle α of 120°. Similarly to the examples shown in FIGS. 6 and 7, effective value Id2f_r is changing in the transition period during current variation. Effective value Id2f_r eventually settles to a certain value. Since effective value Id2f_r decreases temporarily in a time period Tp2 (e.g., 4 ms) of the transition period, second harmonic content rate R2 also decreases. Time period Tp2 is a time period for which condition P1 “(Id2f_r/Id1f_r)≥K” in determination unit 130 is not satisfied when K=15% in condition P1. Therefore, it is necessary to extend the time period of reset timer 142 such that output of the lock signal (e.g., signal D having the value “1”) continues (i.e., such that output of the lock signal is not interrupted).

From the above, as shown in FIG. 5, effective value Id2f_r is constant in the transition period during current variation caused by the occurrence of the fault, and effective value Id2f_r eventually settles to zero. In contrast, as shown in FIGS. 6 to 8, effective value Id2f_r changes relatively greatly in the transition period during current variation caused by the occurrence of inrush (or the time period for which effective value Id2f_r is constant is shorter than the time period for which effective value Id2f_r is constant when the fault occurs), and effective value Id2f_r eventually settles to the certain value.

In the first embodiment, using the above-described characteristics, unlocking unit 150 shown in FIG. 3 is configured to cancel the locking process by locking process unit 140 (i.e., stop output of the lock signal) when rate of change ΔId2f_r in effective value Id2f_r within time period Tc is equal to or more than reference value ε after it is determined that second harmonic content rate R2 is equal to or more than threshold value K and the operation of protective relay device 10 is locked. A delay in operation time caused by second harmonic locking in the fault current in the transition period during current variation is thereby suppressed.

### Operation Examples

Operation examples of protective relay device 10 when a fault occurs and when an inrush current occurs will be described.

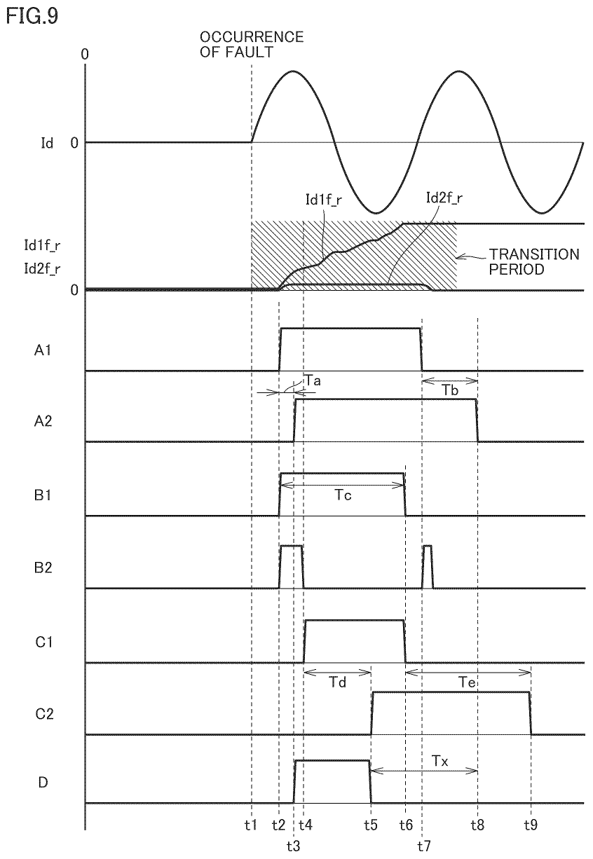

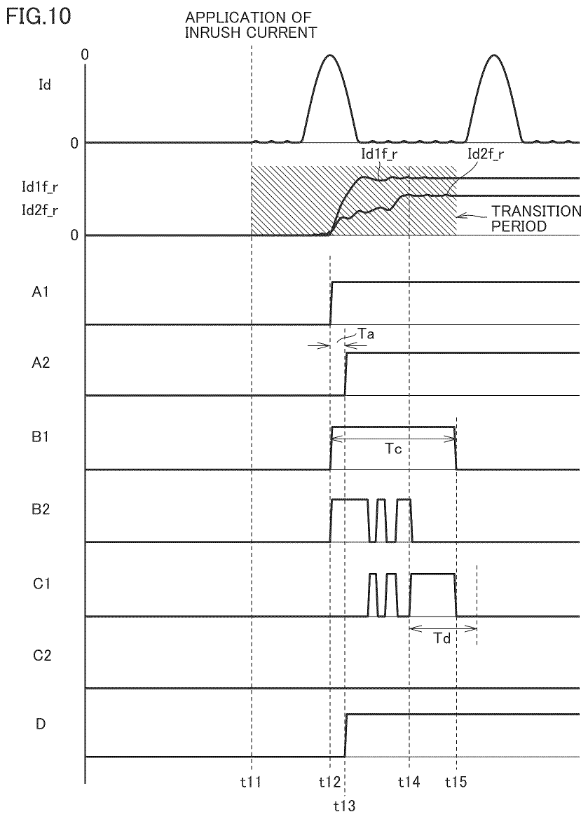

FIG. 9 is a timing chart for illustrating an operation example of the protective relay device according to the first embodiment when a fault occurs. Signals A1, A2, B1, B2, C1, C2, and D in FIG. 9 correspond to signals A1, A2, B1, B2, C1, C2, and D in FIG. 3, respectively. The same applies as well to FIGS. 10 to 12 below.

Referring to FIG. 9, a fault occurs at time t1 and differential current Id increases in amplitude. At time t2, determination unit 130 determines that differential current Id contains a certain amount or more of the second harmonic component (e.g., condition P1 and condition P1a are satisfied), and outputs signal A1 having the value “1”. In addition, at time t2, one-shot timer 151 outputs signal B1 having the value “1”. Furthermore, at time t2, rate of change ΔId2f_r of effective value Id2f_r is equal to or more than reference value ε, and thus, rate-of-change determination unit 152 outputs signal B2 having the value “1”.

At time t3, the value “1” of signal A1 has continued for time period Ta or longer, and in response to this, operation timer 141 outputs the value “1”, and as a result, reset timer 142 outputs signal A2 having the value “1”. At this time, signal C2 has the value “0”, and thus, locking process unit 140 (specifically, AND circuit 143) outputs signal D having the value “1”. As a result, output of the protection signal from ratio differential relay unit 105 is locked, and thus, time t3 is the locking start time. As described above, when the state in which differential current Id contains the certain amount or more of the second harmonic component (e.g., condition P1 is satisfied) continues for time period Ta or longer, locking process unit 140 performs the locking process.

At time t4, effective value Id2f_r is almost constant and rate of change ΔId2f_r is less than reference value ε, and thus, rate-of-change determination unit 152 outputs signal B2 having the value “0”. As a result, signal C1 having the value “1” is output from AND circuit 153.

At time t5, the value “1” of signal C1 has continued for time period Td or longer, and in response to this, operation timer 154 outputs the value “1”, and as a result, reset timer 155 outputs signal C2 having the value “1”. That is, the unlock signal is output from unlocking unit 150. As a result, locking process unit 140 outputs signal D having the value “0” (i.e., the locking process by locking process unit 140 is canceled). Time t5 is the unlocking time at which locking of output of the protection signal from ratio differential relay unit 105 is canceled.

At time t6 when time period Tc has elapsed from time t2, one-shot timer 151 outputs signal B1 having the value “0”. As a result, the value of signal C1 becomes “0”.

At time t7, determination unit 130 determines that differential current Id no longer contains the certain amount or more of the second harmonic component (e.g., condition P1 is no longer satisfied), and outputs signal A1 having the value “0”. At time t8 when time period Tb has elapsed from time t7, reset timer 142 outputs signal A2 having the value “0”. Thereafter, at time t9 when time period Te has elapsed from time t6, reset timer 155 outputs signal C2 having the value “0”. As described above, after time period Te elapses from the end of time period Tc, unlocking unit 150 stops output of the unlock signal.

In a conventional configuration in which the protection signal is locked when the second harmonic content rate is equal to or more than a defined value and locking of the protection signal is canceled when the second harmonic content rate becomes less than the defined value, the locking start time is time t3 and the unlocking time is time t8. In contrast, in the first embodiment, as described above, the locking start time is time t3 and the unlocking time is time t5. Therefore, locking of the protection signal can be canceled earlier by a time period Tx (i.e., t8−t5) in the first embodiment than in the conventional configuration. Thus, a delay in relay operation time caused by second harmonic locking in the fault current can be suppressed.

FIG. 10 is a timing chart for illustrating an example of the operation of the protective relay device according to the first embodiment when an inrush current is applied.

Referring to FIG. 10, at time t11, a simulated inrush current having a conduction angle of 60° is applied. At time t12, determination unit 130 determines that differential current Id contains a certain amount or more of the second harmonic component, and outputs signal A1 having the value “1”. In addition, at time t12, one-shot timer 151 outputs signal B1 having the value “1”. Furthermore, at time t12, rate of change ΔId2f_r is equal to or more than reference value ε, and thus, rate-of-change determination unit 152 outputs signal B2 having the value “1”.

At time t13, the value “1” of signal A1 has continued for time period Ta or longer, and in response to this, operation timer 141 outputs the value “1”, and as a result, reset timer 142 outputs signal A2 having the value “1”. At this time, signal C2 has the value “0”, and thus, locking process unit 140 outputs signal D having the value “1”. As a result, output of the protection signal from ratio differential relay unit 105 is locked, and thus, time t13 is the locking start time.

After time t12, effective value Id2f_r is not constant but changing, and thus, rate of change ΔId2f_r goes above and below reference value ε. Therefore, the value “0” and the value “1” of signal B2 are alternately repeated. In response to this, the value “1” and the value “0” of signal C1 are alternately repeated. Since the value “1” of signal C1 does not continue for time period Td or longer, the value of signal C2 is maintained at “0”.

At time t14, signal C1 has the value “1” and this state continues for a certain time period. At time t15 when time period Tc has elapsed from time t12, one-shot timer 151 outputs signal B1 having the value “0”. As a result, the value of signal C1 becomes “0”.

From the above, after time t13, the value of signal D is maintained at “1”. Therefore, when the inrush current having a conduction angle of 60° occurs, second harmonic locking is not canceled and locking of output of the protection signal from ratio differential relay unit 105 is maintained.

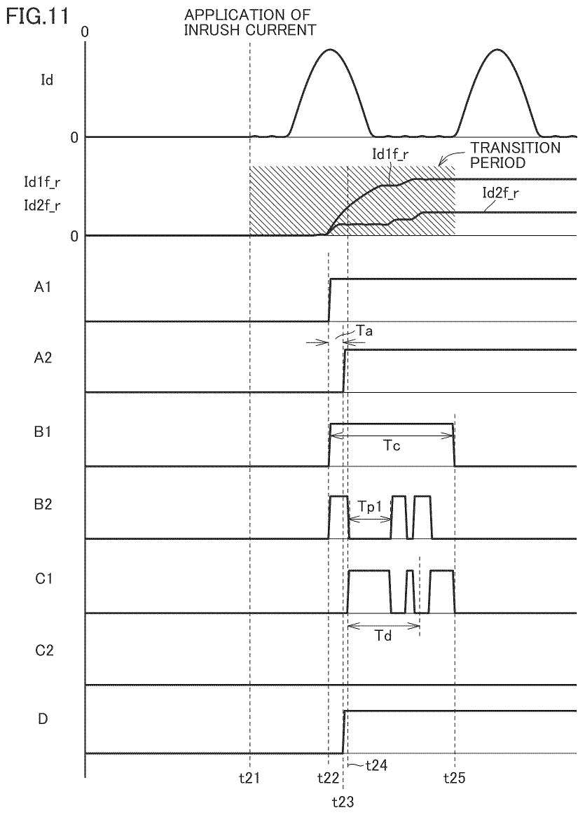

FIG. 11 is a timing chart for illustrating another example of the operation of the protective relay device according to the first embodiment when an inrush current is applied.

Referring to FIG. 11, at time t21, a simulated inrush current having a conduction angle of 90° is applied. At time t22, signal A1 having the value “1” is output, signal B1 having the value “1” is output, and signal B2 having the value “1” is output.

At time t23, the value “1” of signal A1 has continued for time period Ta or longer, and in response to this, signal A2 having the value “1” is output, and as a result, signal D having the value “1” is output. As a result, output of the protection signal from ratio differential relay unit 105 is locked, and thus, time t23 is the locking start time.

In a time period (e.g., time period Tp1 in FIG. 7) after time t24, effective value Id2f_r is almost constant, and thus, rate of change ΔId2f_r is less than reference value ε and signal B2 has the value “0”. In response to this, signal C1 has the value “1” in time period Tp1. However, since time period Tp1 is shorter than time period Td of operation timer 154, the value of signal C2 is maintained at “0”.

At time t25 when time period Tc has elapsed from time t22, one-shot timer 151 outputs signal B1 having the value “0”. As a result, the value of signal C1 becomes “0”.

From the above, after time t23, the value of signal D is maintained at “1”. Therefore, when the inrush current having a conduction angle of 90° occurs, second harmonic locking is not canceled and locking of output of the protection signal from ratio differential relay unit 105 is maintained.

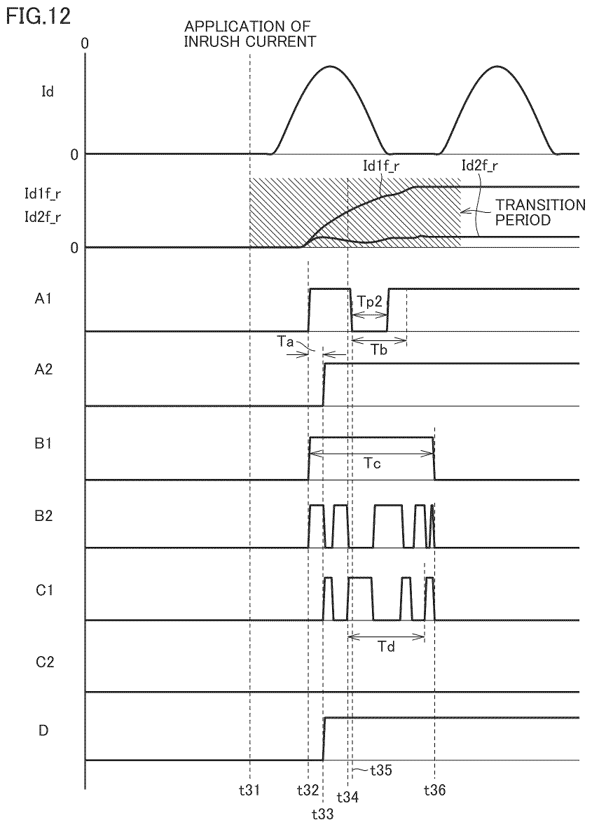

FIG. 12 is a timing chart for illustrating still another example of the operation of the protective relay device according to the first embodiment when an inrush current is applied.

Referring to FIG. 12, at time t31, a simulated inrush current having a conduction angle of 120° is applied. At time t32, signal A1 having the value “1” is output, signal B1 having the value “1” is output, and signal B2 having the value “1” is output.

At time t33, the value “1” of signal A1 has continued for time period Ta or longer, and in response to this, signal A2 having the value “1” is output, and as a result, signal D having the value “1” is output. As a result, output of the protection signal from ratio differential relay unit 105 is locked, and thus, time t33 is the locking start time.

In a time period after time t34, effective value Id2f_r is almost constant, and thus, signal B2 has the value “0” and signal C1 has the value “1”. However, the time period for which signal C1 has the value “1” is less than time period Td of operation timer 154, and thus, the value of signal C2 is maintained at “0”.

In addition, in a certain time period (e.g., time period Tp2 in FIG. 8) after time t35, effective value Id2f_r is small. However, time period Tp2 is shorter than time period Tb of reset timer 142, and thus, the value of signal A2 is maintained at “1”.

At time t36 when time period Tc has elapsed from time t32, one-shot timer 151 outputs signal B1 having the value “0”. As a result, the value of signal C1 becomes “0”.

From the above, after time t33, the value of signal D is maintained at “1”. Therefore, when the inrush current having a conduction angle of 120° occurs, second harmonic locking is not canceled and locking of output of the protection signal from ratio differential relay unit 105 is maintained.

Next, a method for setting above-described time periods Ta to Te will be described more specifically. First, time period Ta of operation timer 141 is set to a short time period (e.g., equal to or more than the electrical angle of 0° and equal to or less than the electrical angle of 60°) such that the inclusion of a certain ratio or more of the second harmonic component with respect to the fundamental wave component can be detected earlier than output of the protection signal by ratio differential relay unit 105 shown in FIG. 3 and output of the protection signal can be locked when the inrush current occurs. In the first embodiment, time period Ta is set to the electrical angle of 30°.

Time period Tb of reset timer 142 is set in consideration of time period Tp2 (see FIG. 8) for which effective value Id2f_r decreases temporarily when the inrush current occurs. As shown in FIG. 12, signal A1 may temporarily reset (i.e., the value is “0” in time period Tp2), and thus, it is necessary to set time period Tb to be longer than time period Tp2 in order to reliably perform second harmonic locking. For example, time period Tp2 is approximately 4 ms (e.g., approximately the electrical angle of 90°), and thus, time period Tb is set to be equal to or more than the electrical angle of 120°.

Time period Tc of one-shot timer 151 is set to be sufficiently longer than time period Td of operation timer 154 and not to be too long relative to the filter for extraction of the second harmonic component and the data length used in effective value computation of the second harmonic component. The reason for this is that effective value Id2f_r is stable after the transition period of effective value computation, and thus, when time period Tc is too long relative to the data length, second harmonic locking confirmed after the lapse of the transition period may be canceled. For example, time period Tc is set to be equal to or more than the electrical angle of 270° and equal to or less than the electrical angle of 360°.

Time period Td of operation timer 154 is set to be longer than time period Tp1 (see FIG. 7) for which effective value Id2f_r is almost constant when the inrush current occurs. As shown in FIG. 11, signal C1 has the value “1” in time period Tp1. However, since time period Tp1 is shorter than time period Td, the value of signal C2 does not become “1”. For example, time period Tp1 is approximately 5 ms (e.g., approximately the electrical angle of 120°), and thus, time period Td is set to be equal to or more than the electrical angle of 150°.

Time period Te of reset timer 155 is set based on a condition that signal A1 is switched to an ON state (e.g., a state in which the value is “1”) and then an ON state of signal C2 continues longer than an ON state of signal A2 in FIG. 9. Assuming that signal B2 is in an OFF state (e.g., a state in which the value is “0”), time period Te is set to satisfy the condition “duration of ON state of signal A1+time period Tb”<“time period Tc+time period Te”. That is, time period Te needs to satisfy time period Te>“duration of ON state of signal A1+time period Tb-time period Tc”. For example, when the duration of ON state of signal A1 is the electrical angle of 360°, time period Tb is the electrical angle of 120°, and time period Tc is the electrical angle of 270°, time period Te is set to be equal to or more than 210°.

In summary, time periods Ta, Tb, Tc, Td, and Te are set to, for example, the electrical angles of 30°, 120°, 270°, 150°, and 210°, respectively.

### <Advantages>

According to the first embodiment, even if output of the protection signal is locked using the second harmonic locking method when the fault occurs, the locking can be canceled earlier (e.g., earlier by time period Tx in FIG. 9) than the conventional configuration. Therefore, a speedup in operation of protective relay device 10 can be achieved. In addition, since the above-described locking is maintained when the inrush current occurs, a malfunction of protective relay device 10 can be prevented.

### Second Embodiment

The first embodiment above describes the configuration in which a speedup in operation of the protective relay device is achieved by canceling the locking of output of the protection signal using the second harmonic locking method, with attention directed to the rate of change in the effective value of the second harmonic component. A second embodiment will describe a configuration in which a speedup in operation of the protective relay device is achieved by using two types of harmonic filters having different characteristics in a second harmonic component locking method to shorten a time period of a reset timer used in the second harmonic locking method.

### <Functional Configuration>

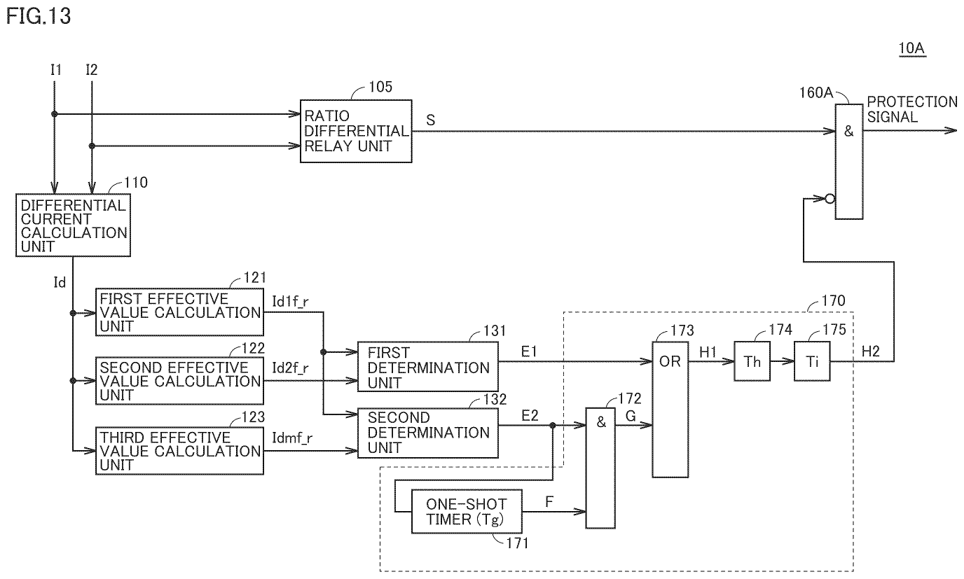

FIG. 13 is a block diagram showing a functional configuration of a protective relay device 10A according to the second embodiment. Although protective relay device 10A corresponds to protective relay device 10 shown in FIG. 1, the symbol “A” is added for the sake of convenience in order to distinguish protective relay device 10A according to the second embodiment from protective relay device 10 according to the first embodiment. The same applies as well to a third embodiment.

Referring to FIG. 13, protective relay device 10A includes, as its main functional configuration, ratio differential relay unit 105, differential current calculation unit 110, first effective value calculation unit 121, second effective value calculation unit 122, a third effective value calculation unit 123, a first determination unit 131, a second determination unit 132, an output control unit 160A, and a locking process unit 170. The functional configuration of each of ratio differential relay unit 105 and differential current calculation unit 110 is the same as the functional configuration described with reference to FIG. 3.

First effective value calculation unit 121 calculates effective value Id1f_r of the fundamental wave component of differential current Id. Second effective value calculation unit 122 calculates effective value Id2f_r of the second harmonic component of differential current Id.

Third effective value calculation unit 123 calculates an effective value Idmf_r of the second harmonic component of differential current Id using a calculation method different from the calculation method used in second effective value calculation unit 122. Specifically, third effective value calculation unit 123 performs the filtering process on differential current Id using a third filter different from the second filter used in second effective value calculation unit 122. Third effective value calculation unit 123 calculates effective value Idmf_r of the second harmonic component of differential current Id having passed through the third filter.

Typically, the third filter adopts a computing equation different from that of the second filter, whereby the third filter is configured as a filter having frequency characteristics that allow a second harmonic component of a power system to pass therethrough and do not allow the other components such as a DC component, a fundamental wave component, a third harmonic component, and a fourth harmonic component to pass therethrough. The third filter has frequency characteristics (e.g., a gain of the passing frequency, and the like) different from those of the second filter, and the computing equation in third effective value calculation unit 123 using the third filter is different from the computing equation in second effective value calculation unit 122 using the second filter.

Alternatively, the third filter is configured as a filter having frequency characteristics that remove a fundamental wave component and a DC component, allow a second harmonic component to pass therethrough, and allow the other harmonic components such as a third harmonic component and a fourth harmonic component to pass therethrough to some extent. The third filter is shorter in data length than the second filter and has frequency characteristics different from those of the second filter. Particularly, differential current Id subjected to the filtering process using the third filter includes the second harmonic component mainly and also includes the other harmonic components to some extent.

First determination unit 131 is substantially the same as determination unit 130 shown in FIG. 3. Specifically, first determination unit 131 calculates the ratio of effective value Id2f_r to effective value Id1f_r as second harmonic content rate R2. Based on whether above-described conditions P1, P1a and P1b are satisfied, first determination unit 131 outputs a signal E1 having the value “1”. Signal E1 corresponds to signal A1 output from determination unit 130 shown in FIG. 3.

Second determination unit 132 receives inputs of effective value Id1f_r and effective value Idmf_r at a certain time t, and calculates a ratio of effective value Idmf_r to effective value Id1f_r (i.e., Idmf_r/Id1f_r) as a harmonic content rate Rm. Second determination unit 132 determines whether a condition Pm that harmonic content rate Rm is equal to or more than a threshold value Km is satisfied. Condition Pm is “(Idmf_r/Id1f_r)≥Km”. Threshold value Km may be the same as threshold value K.

Second determination unit 132 determines whether a condition Pma that a ratio of effective value Idmf_r to rated current Ira (i.e., Idmf_r/Ira) is equal to or more than threshold value k1 is satisfied. Condition Pma is “(Idmf_r/Ira)≥k1”. Furthermore, second determination unit 132 determines whether above-described condition P1b is satisfied. Condition P1b is “(Id1f_r/Ira)≥k2”.

Second determination unit 132 outputs a signal E2 having the value “1” when condition Pm and condition Pma are satisfied, and otherwise outputs signal E2 having the value “0”. In another aspect, second determination unit 132 outputs signal E2 having the value “1” when condition Pm and condition P1b are satisfied, and otherwise outputs signal E2 having the value “0”. In still another aspect, second determination unit 132 outputs signal E2 having the value “1” when all of condition Pm, condition Pma and condition P1b are satisfied, and otherwise outputs signal E2 having the value “0”.

From the above, at least condition Pm needs to be satisfied to output signal E2 having the value “1”.

When at least one of condition P1 and condition Pm is satisfied, locking process unit 170 performs the locking process for locking output of the protection signal (e.g., signal S having the value “1”) for protecting the device to be protected (e.g., transformer 6). Specifically, locking process unit 170 includes a one-shot timer 171, an AND circuit 172, an OR circuit 173, an operation timer 174, and a reset timer 175.

When second determination unit 132 outputs signal E2 having the value “1”, one-shot timer 171 continues to output a signal F having the value “1” to AND circuit 172 for a time period Tg. When time period Tg has elapsed, one-shot timer 171 outputs signal F having the value “0” to AND circuit 172. Time period Tg is set to be, for example, equal to or more than the electrical angle of 270° and equal to or less than the electrical angle of 360° as a time period until computation of effective value Id2f_r is completed.

AND circuit 172 performs an AND operation between the output value of second determination unit 132 and the output value of one-shot timer 171. Specifically, when the output value of second determination unit 132 is “1” and the output value of one-shot timer 171 is “0”, AND circuit 172 outputs a signal G having the value “1”. It is thus understood that determination of harmonic content rate Rm (e.g., determination of condition Pm) by second determination unit 132 is limited to time period Tg of one-shot timer 171. Specifically, after time period Tg elapses since the determination that condition Pm is satisfied, condition Pm is deactivated.

OR circuit 173 performs an OR operation between the output value of first determination unit 131 and the output value of AND circuit 172. Specifically, when the output value of first determination unit 131 is “1” or the output value of AND circuit 172 is “1”, OR circuit 173 outputs a signal H1 having the value “1”.

When the value “1” of signal H1 output from OR circuit 173 continues for a time period Th or longer, operation timer 174 outputs the value “1” to reset timer 175. Time period Th is set to, for example, the electrical angle of 30°. Typically, time period Th is the same as time period Ta shown in FIG. 3.

When the output value of operation timer 174 changes from “0” to “1”, reset timer 175 outputs a signal H2 having the value “1”. The process of outputting signal H2 having the value “1” corresponds to the locking process for locking output of the protection signal. In addition, after a time period Ti elapses since the point in time at which the output value of operation timer 174 has changed from “1” to “0”, reset timer 175 outputs signal H2 having the value “0”. Thus, the locking process ends. Time period Ti is set to, for example, the electrical angle of 60° (i.e., ⅙ cycle).

According to the above-described configuration, when the state in which at least one of signal E1 and signal E2 has the value “1” (e.g., at least one of condition P1 and condition Pm is satisfied) continues for time period Th or longer, locking process unit 170 performs the locking process. In addition, after time period Ti elapses since the end of the above-described state, locking process unit 170 ends the locking process (e.g., outputs signal H2 having the value “0”).

Output control unit 160A performs an AND operation between the output value of ratio differential relay unit 105 and the output value of locking process unit 170 (specifically, reset timer 175) inverted in logic level. When the output value of ratio differential relay unit 105 is “1” and the output value of locking process unit 170 is “0” (i.e., when ratio differential relay unit 105 is operating and the locking process is not being performed), output control unit 160A outputs the value “1”. That is, output control unit 160 outputs the protection signal by ratio differential relay unit 105.

### <Temporal Changes in Various Computed Values>

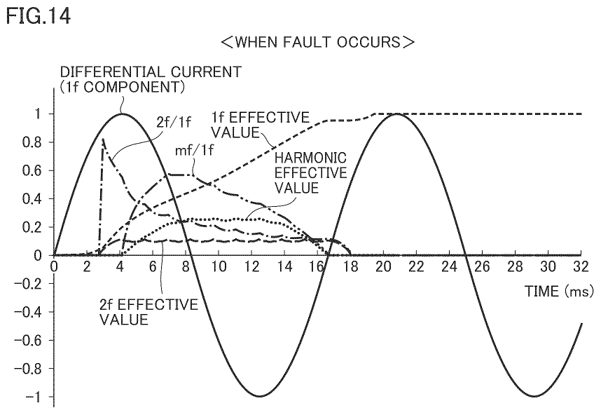

FIG. 14 is a diagram showing temporal changes in various computed values according to the second embodiment when a fault occurs. The vertical axis in FIG. 14 represents second harmonic content rate R2 or harmonic content rate Rm, and the horizontal axis in FIG. 14 represents the time. Specifically, FIG. 14 shows a graph of “harmonic effective value” corresponding to effective value Idmf_r and a graph of “mf/1f” corresponding to harmonic content rate Rm, together with the graphs shown in FIG. 5. Referring to FIG. 14, effective value Idmf_r increases to a value larger than effective value Id2f_r, and eventually reaches zero. Harmonic content rate Rm also increases and eventually reaches zero accordingly.

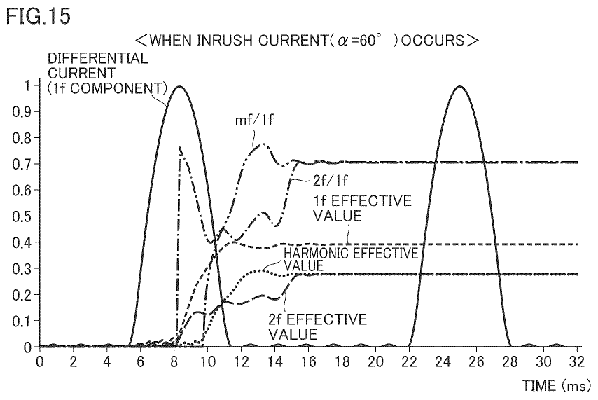

FIG. 15 is a diagram showing an example of temporal changes in various computed values according to the second embodiment when an inrush current occurs. The vertical axis in FIG. 15 represents second harmonic content rate R2 or harmonic content rate Rm, and the horizontal axis in FIG. 15 represents the time. FIG. 15 shows a graph of “harmonic effective value” and a graph of “mf/1f”, together with the graphs shown in FIG. 6.

When the third filter adopts the computing equation different from that of the second filter, whereby the third filter is a filter having frequency characteristics that allow a second harmonic component to pass therethrough and do not allow the other components such as a DC component, a fundamental wave component, a third harmonic component, and a fourth harmonic component to pass therethrough, effective value Idmf_r settles to a certain value while changing constantly.

When the third filter is a filter having frequency characteristics that remove a fundamental wave component and a DC component, allow a second harmonic component to pass therethrough, and allow the other harmonic components such as a third harmonic component and a fourth harmonic component to pass therethrough to some extent, the third harmonic component, the fourth harmonic component and the subsequent higher-order harmonic components are included in the inrush current, and thus, effective value Idmf_r changes in accordance with these harmonic components. However, since the operation of AND circuit 172 is limited to time period Tg of one-shot timer 171, the behavior after time period Tg does not affect the operation of output control unit 160A.

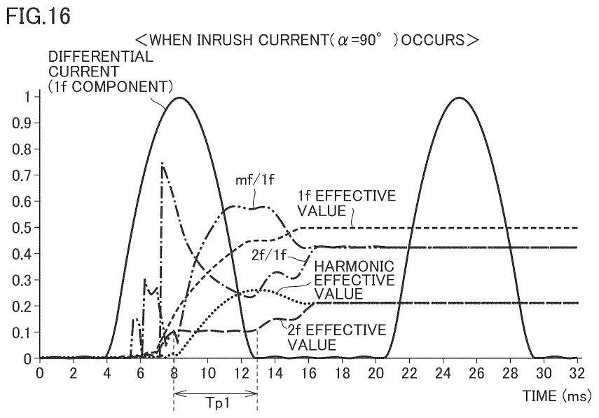

FIG. 16 is a diagram showing another example of temporal changes in various computed values according to the second embodiment when an inrush current occurs. The vertical axis in FIG. 16 represents second harmonic content rate R2 or harmonic content rate Rm, and the horizontal axis in FIG. 16 represents the time. FIG. 16 shows a graph of “harmonic effective value” and a graph of “mf/1f”, together with the graphs shown in FIG. 7. Effective value Idmf_r settles to a certain value while changing.

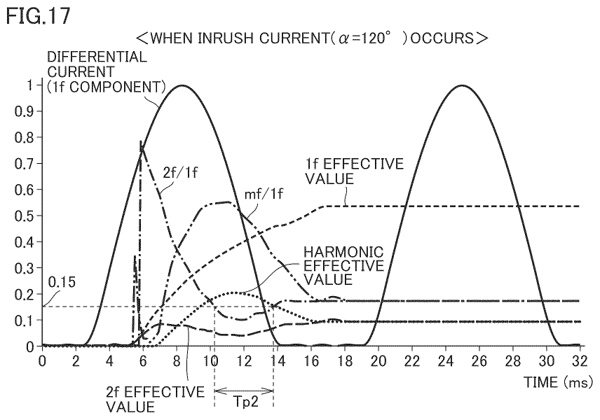

FIG. 17 is a diagram showing still another example of temporal changes in various computed values according to the second embodiment when an inrush current occurs. The vertical axis in FIG. 17 represents second harmonic content rate R2 or harmonic content rate Rm, and the horizontal axis in FIG. 17 represents the time. FIG. 17 shows a graph of “harmonic effective value” and a graph of “mf/1f”, together with the graphs shown in FIG. 8. In time period Tp2, effective value Id2f_r increases, although effective value Id2f_r decreases temporarily. In response to this, in time period Tp2, second harmonic content rate R2 decreases temporarily. However, harmonic content rate Rm is maintained at a value equal to or larger than threshold value Km (e.g., 15%) for detection of the inrush current. Therefore, the state in which at least one of condition P1 and condition Pm is satisfied is continued.

The time span for which second harmonic content rate R2 decreases (i.e., time period Tp2) varies depending on the filter computing equation of the second filter, the data length used in the computation, and the like. The filter computing equation of the third filter is configured such that harmonic content rate Rm can compensate for the decrease in second harmonic content rate R2 in time period Tp2 (e.g., such that harmonic content rate Rm is equal to or more than threshold value Km in time period Tp2).

### Operation Examples

Operation examples of protective relay device 10A when a fault occurs and when an inrush current occurs will be described.

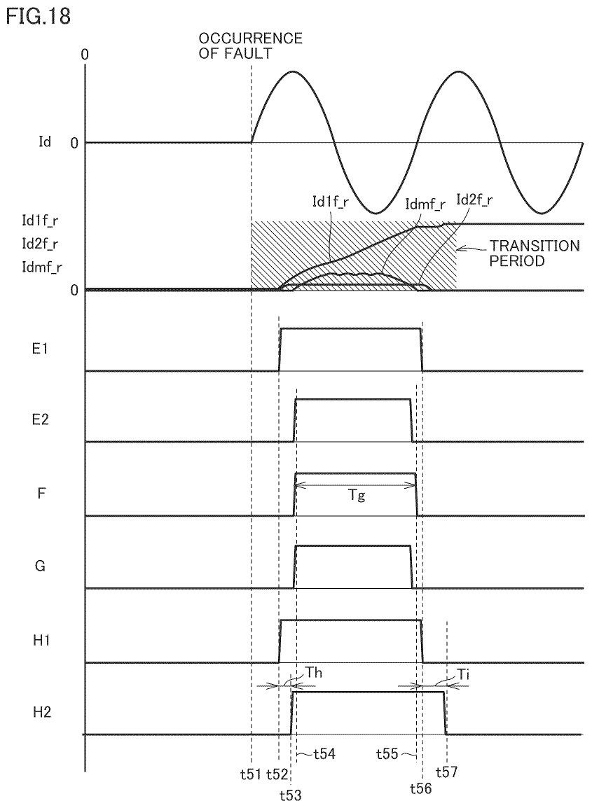

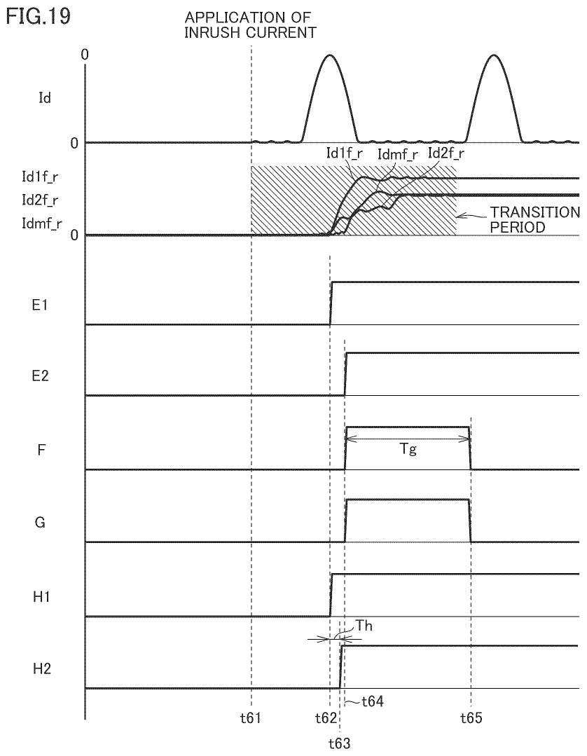

FIG. 18 is a timing chart for illustrating an operation example of the protective relay device according to the second embodiment when a fault occurs. Signals E1, E2, F, G, H1, and H2 in FIG. 18 correspond to signals E1, E2, F, G, H1, and H2 in FIG. 13, respectively. The same applies as well to FIGS. 19 to 21 below.

Referring to FIG. 18, a fault occurs at time t51 and differential current Id increases in amplitude. At time t52, first determination unit 131 determines that differential current Id contains a certain amount or more of the second harmonic component, and outputs signal E1 having the value “1”. In addition, at time t52, OR circuit 173 outputs signal H1 having the value “1”.

At time t53, the value “1” of signal E1 has continued for time period Th or longer, and in response to this, operation timer 174 outputs the value “1”, and as a result, reset timer 175 outputs signal H2 having the value “1”. That is, locking process unit 170 outputs the lock signal. As a result, output of the protection signal from ratio differential relay unit 105 is locked, and thus, time t53 is the locking start time.

At time t54, second determination unit 132 determines that differential current Id contains a certain amount or more of the harmonic component, and outputs signal E2 having the value “1”. In addition, at time t54, one-shot timer 171 outputs signal F having the value “1”. As a result, signal G having the value “1” is output from AND circuit 172.

At time t55 when time period Tg has elapsed from time t54, one-shot timer 171 outputs signal F having the value “0”. Shortly before time t55, second determination unit 132 determines that differential current Id does not contain the certain amount or more of the harmonic component, and outputs signal E2 having the value “0”. Therefore, the value of signal G is also “0”.

At time t56, first determination unit 131 determines that differential current Id does not contain the certain amount or more of the second harmonic component, and outputs signal E1 having the value “0”. At this point in time, signal G has the value “0”, and thus, the value of signal H1 becomes “0”.

At time t57 when time period Ti has elapsed from time t56, reset timer 175 outputs signal H2 having the value “0”. As a result, locking of output of the protection signal is canceled. Therefore, time t57 is the unlocking time.

FIG. 19 is a timing chart for illustrating an example of the operation of the protective relay device according to the second embodiment when an inrush current is applied.

Referring to FIG. 19, at time t61, a simulated inrush current having a conduction angle of 60° is applied. At time t62, first determination unit 131 determines that differential current Id contains a certain amount or more of the second harmonic component, and outputs signal E1 having the value “1”. In addition, at time t62, OR circuit 173 outputs signal H1 having the value “1”.

At time t63, the value “1” of signal E1 has continued for time period Th or longer, and in response to this, operation timer 174 outputs the value “1”, and as a result, reset timer 175 outputs signal H2 having the value “1”. As a result, output of the protection signal from ratio differential relay unit 105 is locked, and thus, time t63 is the locking start time.

At time t64, second determination unit 132 determines that differential current Id contains a certain amount or more of the harmonic component, and outputs signal E2 having the value “1”. In addition, at time t64, one-shot timer 171 outputs signal F having the value “1”. As a result, signal G having the value “1” is output from AND circuit 172.

At time t65 when time period Tg has elapsed from time t64, one-shot timer 171 outputs signal F having the value “0”. As a result, the value of signal G also becomes “0”.

From the above, after time t63, the value of signal H2 is maintained at “1”. Therefore, when the inrush current having a conduction angle of 60° occurs, locking of output of the protection signal from ratio differential relay unit 105 is maintained.

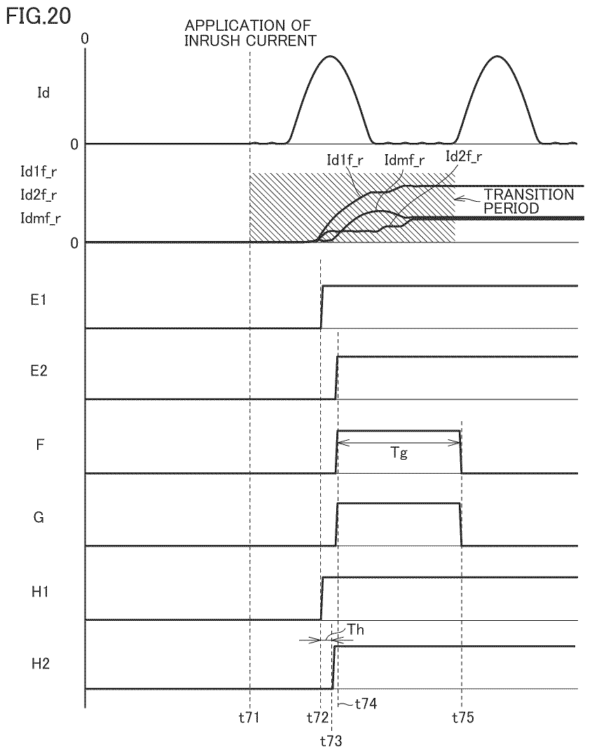

FIG. 20 is a timing chart for illustrating another example of the operation of the protective relay device according to the second embodiment when an inrush current is applied.

Referring to FIG. 20, at time t71, a simulated inrush current having a conduction angle of 90° is applied. At time t72, signal E1 having the value “1” is output, and signal H1 having the value “1” is output.

At time t73, the value “1” of signal E1 has continued for time period Th or longer, and in response to this, signal H2 having the value “1” is output. As a result, output of the protection signal from ratio differential relay unit 105 is locked, and thus, time t73 is the locking start time. At time t74, signal E2 having the value “1” is output, and signal F having the value “1” is output. As a result, signal G having the value “1” is output.

At time t75 when time period Tg has elapsed from time t74, signal F having the value “0” is output. As a result, the value of signal G also becomes “0”.

From the above, after time t73, the value of signal H2 is maintained at “1”. Therefore, when the inrush current having a conduction angle of 90° occurs, locking of output of the protection signal from ratio differential relay unit 105 is maintained.

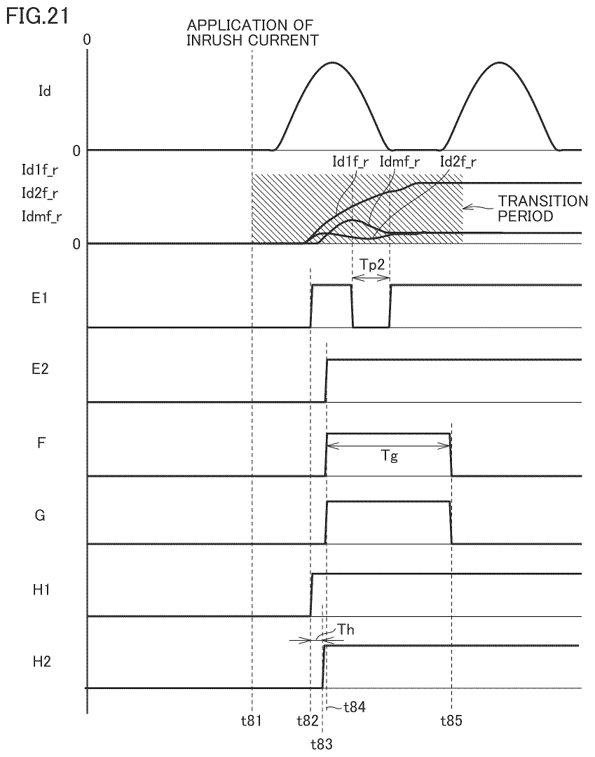

FIG. 21 is a timing chart for illustrating still another example of the operation of the protective relay device according to the second embodiment when an inrush current is applied.

Referring to FIG. 21, at time t81, a simulated inrush current having a conduction angle of 120° is applied. At time t82, signal E1 having the value “1” is output, and signal H1 having the value “1” is output.

At time t83, the value “1” of signal E1 has continued for time period Th or longer, and in response to this, signal H2 having the value “1” is output. As a result, output of the protection signal from ratio differential relay unit 105 is locked, and thus, time t83 is the locking start time. At time t84, signal E2 having the value “1” is output, and signal F having the value “1” is output. As a result, signal G having the value “1” is output.

In time period Tp2 (corresponding to time period Tp2 in FIG. 17, for example) after time t84, effective value Id2f_r is small, and thus, second harmonic content rate R2 is less than threshold value K and signal E1 has the value “0”. However, in time period Tp2, effective value Idmf_r is maintained at a large value and harmonic content rate Rm is equal to or more than threshold value Km, and thus, the value of signal E2 remains at “1”. As a result, the value of signal H2 is maintained at “1”. That is, locking of output of the protection signal from ratio differential relay unit 105 is maintained.

At time t85 when time period Tg has elapsed from time t84, signal F having the value “0” is output. As a result, the value of signal G also becomes “0”.

From the above, after time t83, the value of signal H2 is maintained at “1”. Therefore, when the inrush current having a conduction angle of 120° occurs, locking of output of the protection signal from ratio differential relay unit 105 is maintained.

As described above, the time period for which second harmonic content rate R2 is less than threshold value K (e.g., time period Tp2) may be present after the inrush current occurs. Therefore, when output of the protection signal is locked using only second harmonic content rate R2, locking may be temporarily canceled. In order to prevent this, it is necessary to set the time period of the reset timer relating to determination of second harmonic content rate R2 to be relatively long. For example, referring to FIG. 12, time period Tb of reset timer 142 in the first embodiment is set to be longer than time period Tp2 (set to the electrical angle of 120°, for example), and thus, the value of signal A2 is maintained at “1” (i.e., locking of output of the protection signal is not canceled). Time period Tb is equivalent to the time period of the reset timer used in the conventional second harmonic locking method.

In contrast, in the second embodiment, as described with reference to FIG. 21, even when the time period for which second harmonic content rate R2 is less than threshold value K (e.g., time period Tp2) is present, harmonic content rate Rm is equal to or more than threshold value Km in this time period, and thus, locking of output of the protection signal is not canceled. Therefore, it is unnecessary to set the time period of the reset timer relating to determination of second harmonic content rate R2 to be long. Therefore, time period Ti of reset timer 175 shown in FIGS. 13 and 18 can be set to be shorter than the time period (e.g., time period Tb) of the reset timer used in the conventional second harmonic locking method, and is set to, for example, the electrical angle of 60°.

Thus, the time period of the reset timer can be made shorter in the second embodiment than in the conventional configuration, which can result in earlier cancellation of locking of the protection signal. Therefore, a delay in relay operation time caused by second harmonic locking in the fault current can be suppressed.

### <Advantages>

According to the second embodiment, even if output of the protection signal is locked using the second harmonic locking method when the fault occurs, the locking can be canceled earlier (e.g., earlier by the reduction in time period of the reset timer) than the conventional second harmonic locking method. Therefore, a speedup in operation of the protective relay device can be achieved. In addition, since the above-described locking is maintained when the inrush current occurs, a malfunction of the protective relay device can be prevented.

### Third Embodiment

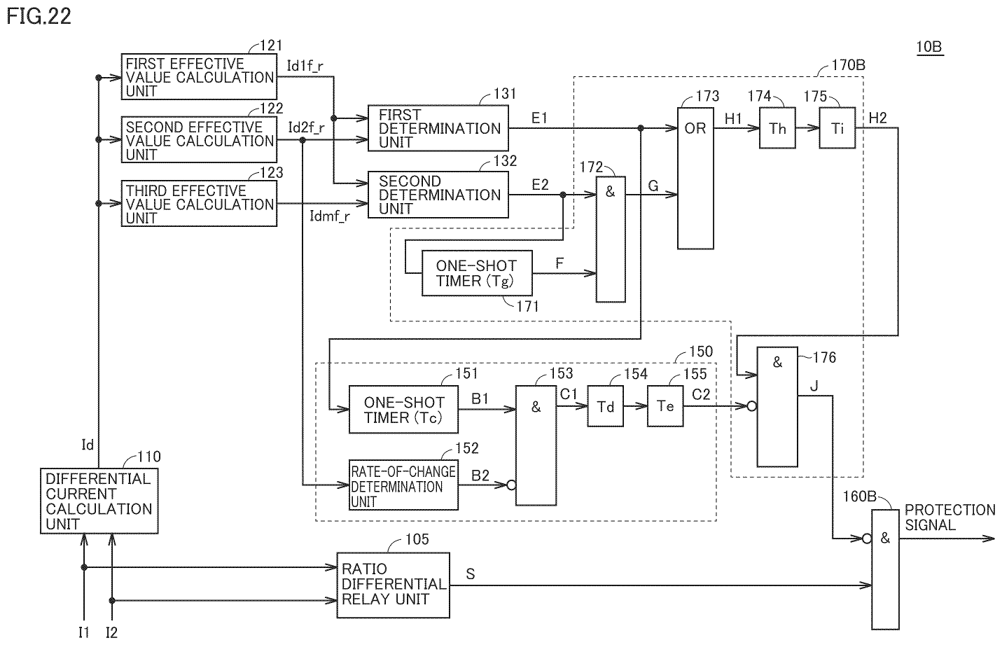

A third embodiment corresponds to a combination of the first embodiment and the second embodiment. FIG. 22 is a block diagram showing a functional configuration of a protective relay device 10B according to the third embodiment. Protective relay device 10B includes, as its main functional configuration, ratio differential relay unit 105, differential current calculation unit 110, first effective value calculation unit 121, second effective value calculation unit 122, third effective value calculation unit 123, first determination unit 131, second determination unit 132, unlocking unit 150, an output control unit 160B, and a locking process unit 170B. Among these components, the configurations of the components other than output control unit 160B and locking process unit 170B are as described with reference to FIG. 3 or 13.

Locking process unit 170B has a configuration in which an AND circuit 176 is added to locking process unit 170 shown in FIG. 13. AND circuit 176 performs an AND operation between the output value of reset timer 175 and the output value of unlocking unit 150 inverted in logic level. Specifically, when the output value of reset timer 175 is “1” and the output value of unlocking unit 150 is “0” (i.e., when the unlock signal for canceling locking is not output by unlocking unit 150), AND circuit 176 outputs a signal J having the value “1” (e.g., the lock signal for locking output of the protection signal). The process of outputting signal J having the value “1” corresponds to the locking process for locking output of the protection signal.

Output control unit 160B is configured as an AND circuit, for example. Output control unit 160B performs an AND operation between the output value of ratio differential relay unit 105 and the output value of locking process unit 170B (specifically, AND circuit 176) inverted in logic level. When the output value of ratio differential relay unit 105 is “1” and the output value of locking process unit 170B is “0” (i.e., when ratio differential relay unit 105 is operating and the locking process is not being performed), output control unit 160B outputs the value “1”. That is, output control unit 160B outputs the protection signal by ratio differential relay unit 105.

When the output value of locking process unit 170B is “1” even if the output value of ratio differential relay unit 105 is “1” (i.e., when the locking process is being performed even if ratio differential relay unit 105 is operating), output control unit 160B outputs the value “0”. That is, output control unit 160B does not output the protection signal by ratio differential relay unit 105.

According to the third embodiment, the advantages of the first and second embodiments are obtained. Specifically, when the fault current hardly includes the harmonic components such as the second harmonic component, the presence of the time period for which the second harmonic effective value is constant makes it possible to distinguish between the fault current and the inrush current. Therefore, in the third embodiment, locking can be canceled quickly at time t5 in FIG. 9, similarly to the first embodiment.

When the fault current includes the higher-order harmonic components than the fundamental wave component, the second harmonic effective value may vary due to an influence of the higher-order harmonic components and the cancellation of locking may be delayed. In this case as well, in the third embodiment, the time period of the reset timer relating to determination of second harmonic content rate R2 can be shortened, and thus, locking can be canceled as early as possible, similarly to the second embodiment.

### Other Embodiments

(1) The embodiments above describe the second harmonic locking method built into the ratio differential relay device for protecting the transformer. However, in order to prevent a malfunction caused by an inrush current, the second harmonic locking method may also be built into an overcurrent relay used as backup protection of a transformer. In this case as well, a speedup in protective relay operation can be achieved by the same method as the above.
(2) The embodiments above describe the case in which protective relay device 10 is a protective relay device for protecting the transformer. However, protective relay device 10 is not limited to this configuration. Protective relay device 10 may, for example, be applied as a ratio differential relay device for protecting a power transmission line or the like.

The configurations illustrated as the embodiments described above are exemplary configurations of the present disclosure, and can be combined with another known technique, or can be modified, such as partially omitted, without departing from the gist of the present disclosure. Further, in each embodiment described above, the processing and configuration described in another embodiment may be appropriately adopted and implemented.

### ADDITIONAL NOTES

Aspects of the present disclosure will be summarized below as additional notes.

### (Additional Note 1)

A protective relay device for protecting a device to be protected, the protective relay device comprising: a first effective value calculation unit to calculate a first effective value of a fundamental wave component of a differential current calculated from a primary current and a secondary current of the device to be protected; a second effective value calculation unit to calculate a second effective value of a second harmonic component of the differential current; a determination unit to determine whether a first condition is satisfied, the first condition being a condition that a ratio of the second effective value to the first effective value is equal to or more than a threshold value; a locking process unit to perform a locking process for locking output of a protection signal for protecting the device to be protected, when the first condition is satisfied; and an unlocking unit to cancel the locking process based on a result of determination by the determination unit and a rate of change in the second effective value, wherein when, within a first time period since a determination that the first condition is satisfied, a state in which the rate of change is less than a reference value continues for a second time period or longer, the unlocking unit outputs an unlock signal for canceling the locking process.

### (Additional Note 2)

The protective relay device according to Additional Note 1, wherein the first time period is longer than the second time period.

### (Additional Note 3)

The protective relay device according to Additional Note 1 or 2, wherein the unlocking unit stops output of the unlock signal after a third time period elapses since an end of the first time period.

### (Additional Note 4)

The protective relay device according to Additional Note 3, wherein the third time period is shorter than the first time period and longer than the second time period.

### (Additional Note 5)

The protective relay device according to any one of Additional Notes 1 to 4, wherein the locking process unit performs the locking process when a state in which the first condition is satisfied continues for a fourth time period or longer.

(Additional Note 6) The protective relay device according to any one of Additional Notes 1 to 5, wherein the device to be protected is a transformer, the protective relay device further comprising: a relay unit to perform a ratio differential relay computation based on a suppression current calculated from the primary current and the secondary current and the differential current; and an output control unit to output the protection signal based on a result of the ratio differential relay computation and whether the locking process is performed.

Although the present embodiment has been described, it should be understood that the embodiments disclosed herein are illustrative and non-restrictive in every respect. The scope of the present disclosure is defined by the terms of the claims and is intended to include any modifications within the scope and meaning equivalent to the terms of the claims.

What is claimed is:

1. A protective relay device for protecting a device to be protected, the protective relay device comprising:
a processor; and
a memory that stores a program executed by the processor, wherein the processor is configured to:
calculate a first effective value of a fundamental wave component of a differential current calculated from a primary current and a secondary current of the device to be protected;
calculate a second effective value of a second harmonic component of the differential current;
determine whether a first condition is satisfied, the first condition being a condition that a ratio of the second effective value to the first effective value is equal to or more than a threshold value;
perform a locking process for locking output of a protection signal for protecting the device to be protected, when the first condition is satisfied; and
cancel the locking process based on the first condition and a rate of change in the second effective value, and
when, within a first time period since a determination that the first condition is satisfied, a state in which the rate of change is less than a reference value continues for a second time period or longer, the processor is configured to output an unlock signal for canceling the locking process.

2. The protective relay device according to claim 1, wherein
the first time period is longer than the second time period.

3. The protective relay device according to claim 1, wherein
the processor is configured to stop output of the unlock signal after a third time period elapses since an end of the first time period.

4. The protective relay device according to claim 3, wherein
the third time period is shorter than the first time period and longer than the second time period.

5. The protective relay device according to claim 1, wherein
the processor is configured to perform the locking process when a state in which the first condition is satisfied continues for a fourth time period or longer.

6. The protective relay device according to claim 1, wherein
the device to be protected is a transformer, and
the processor is configured to:
perform a ratio differential relay computation based on a suppression current calculated from the primary current and the secondary current and the differential current; and
output the protection signal based on a result of the ratio differential relay computation and whether the locking process is performed.

7. The protective relay device according to claim 2, wherein
the processor is configured to stop output of the unlock signal after a third time period elapses since an end of the first time period.

8. The protective relay device according to claim 2, wherein
the processor is configured to perform the locking process when a state in which the first condition is satisfied continues for a fourth time period or longer.

9. The protective relay device according to claim 3, wherein
the processor is configured to perform the locking process when a state in which the first condition is satisfied continues for a fourth time period or longer.

10. The protective relay device according to claim 4, wherein
the processor is configured to perform the locking process when a state in which the first condition is satisfied continues for a fourth time period or longer.

11. The protective relay device according to claim 2, wherein
the device to be protected is a transformer, and
the processor is configured to:
perform a ratio differential relay computation based on a suppression current calculated from the primary current and the secondary current and the differential current; and
output the protection signal based on a result of the ratio differential relay computation and whether the locking process is performed.

12. The protective relay device according to claim 3, wherein
the device to be protected is a transformer, and
the processor is configured to:
perform a ratio differential relay computation based on a suppression current calculated from the primary current and the secondary current and the differential current; and
output the protection signal based on a result of the ratio differential relay computation and whether the locking process is performed.

13. The protective relay device according to claim 4, wherein
the device to be protected is a transformer, and
the processor is configured to:
perform a ratio differential relay computation based on a suppression current calculated from the primary current and the secondary current and the differential current; and
output the protection signal based on a result of the ratio differential relay computation and whether the locking process is performed.

14. The protective relay device according to claim 5, wherein
the device to be protected is a transformer, and
the processor is configured to:
perform a ratio differential relay computation based on a suppression current calculated from the primary current and the secondary current and the differential current; and
output the protection signal based on a result of the ratio differential relay computation and whether the locking process is performed.
